(19) United States
(12) Patent Application Publication
(10) Pub. No.: US 2022/0334222 A1
(43) Pub. Date: Oct. 20, 2022

(54) LIDAR APPARATUS AND CONTROL METHOD THEREOF

(71) Applicant: HL KLEMOVE CORP., Incheon (KR)

(72) Inventors: Chulseung LEE, Gyeonggi-do (KR); HoSeok SHIN, Gyeonggi-do (KR); Seong Hee JEONG, Gyeonggi-do (KR); Yun Ki HAN, Gyeonggi-do (KR); Hak Gu HAN, Gyeonggi-do (KR)

(21) Appl. No.: 17/721,357

(22) Filed: Apr. 15, 2022

(30) Foreign Application Priority Data
Apr. 16, 2021 (KR) 10-2021-0049847

(51) Int. Cl. G01S 7/483; G01S 17/08; G01D 5/14; G01S 7/48; G01S 7/481

(52) U.S. Cl. CPC G01S 7/483; G01S 17/08; G01D 5/145; G01S 7/4808; G01S 7/4817; G01S 17/931

(57) ABSTRACT

The present disclosure provides a lidar apparatus, comprising: a light source for emitting pulsed light; a light sensor for detecting reflected light by an object from which the pulsed light is reflected and returned; a reflector having a plurality of reflective surfaces, and for reflecting the pulsed light and transmitting it to the object, and reflecting the reflected light and transmitting it to the light sensor; a motor for rotating the reflector; an encoder for detecting a rotational position of the reflector and outputting a detection signal; and a controller for controlling emission timing of the light source and detection time of the light sensor using the detection signal.

### CROSS-REFERENCE TO RELATED APPLICATION

This application claims priority to and the benefit of Korean Patent Application No. 10-2021-0049847, filed on Apr. 16, 2021, the disclosure of which is incorporated herein by reference in its entirety.

### BACKGROUND

### 1. Field of the Invention

The present disclosure relates to a lidar apparatus and a control method thereof.

### 2. Discussion of Related Art

Recently, in the field of autonomous vehicles and intelligent vehicles, an active response function of a vehicle to an unexpected situation is required. In other words, it is necessary to check in advance the situation that threatens the safety of drivers and pedestrians, including recognizing the sudden appearance of pedestrians, detecting obstacles outside the range of lighting in the dark at night, detecting obstacles due to weakening of headlight lighting in rainy weather, or detecting road damage in advance.

In response to this demand, a vehicle LiDAR (Light Detection And Ranging) apparatus has been developed. The lidar apparatus is installed on the windshield of the vehicle or the front of the vehicle to obtain an image of the front of the vehicle based on the self-emitted light. If the vehicle is moving, the lidar apparatus can check for objects ahead and warn the driver in advance. The lidar apparatus transmits an image, which is a basis for the vehicle itself to stop or avoid obstacles, to an electronic control unit (ECU) of the vehicle. The electronic control unit performs various controls using the image received from the lidar apparatus.

The lidar apparatus detects the object by calculating the distance from the lidar apparatus to the object by measuring the time difference between the pulsed light emitted from the light source and the reflected light reflected back by the object.

The lidar apparatus is classified into a mechanical (rotary) lidar apparatus with a reflector and a flash type lidar apparatus without a reflector, depending on the presence or absence of a reflector. Here, the mechanical lidar apparatus requires a motor to rotate the reflector, and the motor should be rotated at a constant speed in order to maintain the horizontal resolution of the lidar apparatus at a certain level.

In general, the mechanical lidar apparatus ensures constant speed rotation of the motor in a method that the control unit receives the rotation speed of the motor as feedback and adjusts the motor control signal according to the rotation speed of the motor.

However, this method has a problem in that it cannot satisfy the specification of a lidar apparatus requiring a jitter performance of 0.5% or less.

The above information disclosed in this Background section is only for enhancement of understanding of the background of the disclosure and it may therefore contain information that does not form the prior art that is already known to a person of ordinary skill in the art.

### SUMMARY OF THE INVENTION

The present disclosure is directed to providing a lidar apparatus and a control method thereof capable of improving the horizontal resolution of the lidar apparatus as well as using a relatively low-spec motor for the lidar apparatus, thereby reducing the manufacturing cost of the lidar apparatus.

In addition, the present disclosure is directed to providing a lidar apparatus and a control method thereof capable of blocking detection of a noise signal unnecessary for object detection and reducing a data capacity for processing the sensing signal.

The technical problems to be achieved in the present disclosure are not limited to the technical problems mentioned above, and other technical problems not mentioned will be clearly understood by those of ordinary skill in the art from the following description.

The present disclosure provides a lidar apparatus, comprising: a light source for emitting pulsed light; a light sensor for detecting reflected light by an object from which the pulsed light is reflected and returned; a reflector having a plurality of reflective surfaces, and for reflecting the pulsed light and transmitting it to the object, and reflecting the reflected light and transmitting it to the light sensor; a motor for rotating the reflector; an encoder for detecting a rotational position of the reflector and outputting a detection signal; and a controller for controlling emission timing of the light source and detection time of the light sensor using the detection signal.

Here, the controller controls the light source to emit the pulsed light when the detection signal is input from the encoder.

In addition, the controller controls the light source to emit the pulsed light at each predetermined rotational position of the reflector.

In addition, the controller controls the light sensor to detect the reflected light during at least a partial section of an output section of the detection signal.

In addition, the reflector is formed of a polyhedron having the plurality of reflective surfaces disposed on its side surfaces.

In addition, the reflector and the encoder are coupled to a motor shaft of the motor and rotate together with the motor shaft.

In addition, the encoder is a magnetic encoder including a multipole magnet and a hall sensor, or an optical encoder including a photodiode and a slit member in which a plurality of slits are formed.

In addition, the present disclosure provides a control method of a lidar apparatus, the method comprising: emitting, by a light source, pulsed light; reflecting, by a reflector, the pulsed light and transmitting it to an object; reflecting, by the object, the pulsed light; reflecting, by the reflector, the reflected light reflected by the object and transmitting it to a light sensor; detecting, by the light sensor, the reflected light; rotating, by a motor, the reflector; detecting, by an encoder, a rotational position of the reflector and outputting a detection signal; and controlling, by a controller, emission timing of the light source and detection time of the light sensor using the detection signal.

According to the present disclosure, even if the motor does not rotate at a constant speed, the encoder detects a specific rotational position of the reflector, and the controller controls the light source to emit pulsed light at the detected specific rotational position, and thus the horizontal resolution of the lidar apparatus can be improved and also it is possible to use a relatively low-spec motor for the lidar apparatus, thereby reducing the manufacturing cost of the lidar apparatus.

In addition, according to the present disclosure, the light sensor detects the reflected light only during a specific detection time with a high probability of receiving the reflected light, and thus it is possible to block detection of a noise signal unnecessary for object detection and to reduce a data capacity for processing the sensing signal.

The effects of the present disclosure are not limited to those mentioned above, and other effects not mentioned will be clearly understood by those of ordinary skill in the art from the following description.

### BRIEF DESCRIPTION OF THE DRAWINGS

The above and other aspects, features, and advantages of the present disclosure will become more apparent to those of ordinary skill in the art by describing embodiments thereof in detail with reference to the accompanying drawings, in which:

FIG. 1 is a schematic block diagram of a lidar apparatus according to an exemplary embodiment of the present disclosure;

FIG. 2 is an exploded perspective view of a reflector, a motor, and an encoder of a lidar apparatus according to an exemplary embodiment of the present disclosure;

FIG. 3 is a cross-sectional view of a motor of a lidar apparatus according to a first embodiment of the present disclosure;

FIG. 4 is a cross-sectional view of a motor of a lidar apparatus according to a second embodiment of the present disclosure;

FIG. 5 is a cross-sectional view of a motor of a lidar apparatus according to a third embodiment of the present disclosure;

FIG. 6 is a cross-sectional view of a motor of a lidar apparatus according to a fourth embodiment of the present disclosure;

FIG. 7 is a graph showing a detection signal (a) output by an encoder according to a specific rotational position of a reflector, an emission signal (b) of a light source output by a controller according to the detection signal, and a sensing signal (c) in which a light sensor detects reflected light during a specific section of the output section of the detection signal, respectively, in a lidar apparatus according to an exemplary embodiment of the present disclosure;

FIG. 8 is a flowchart of a control method of a lidar apparatus according to an exemplary embodiment of the present disclosure;

### DETAILED DESCRIPTION OF EXAMPLE EMBODIMENTS

Hereinafter, exemplary embodiments of the present disclosure will be described in detail so that those of ordinary skill in the art can readily implement the present disclosure with reference to the accompanying drawings. The present disclosure may be embodied in many different forms and are not limited to the embodiments set forth herein. In the drawings, parts unrelated to the description are omitted for clarity of description of the present disclosure. Throughout the specification, like reference numerals denote like elements.

It is understood that the terms “comprise” or “have” when used in this specification, are intended to specify the presence of stated features, integers, steps, operations, elements, components and/or a combination thereof but not preclude the possibility of the presence or addition of one or more other features, integers, steps, operations, elements, components, or a combination thereof.

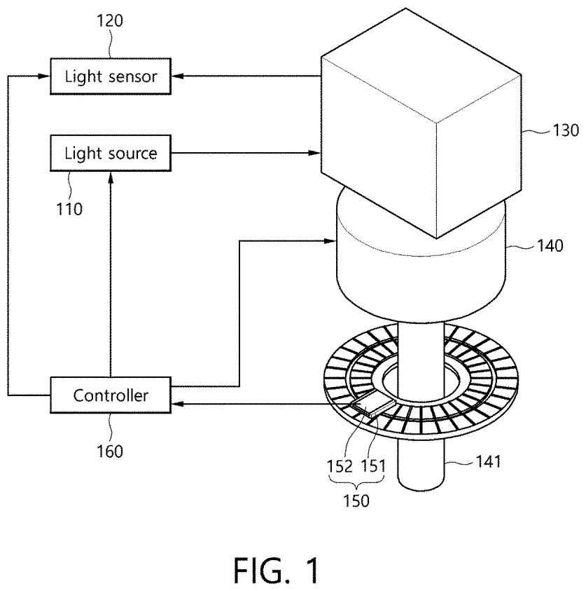

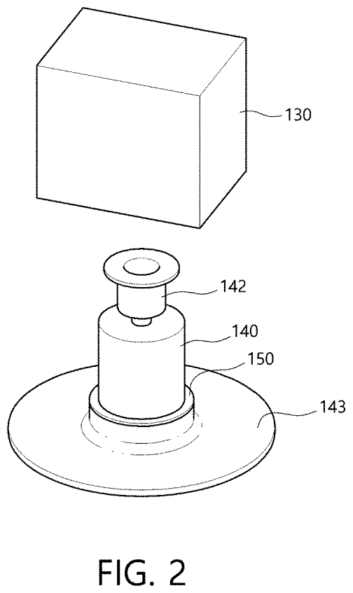

FIG. 1 is a schematic block diagram of a lidar apparatus according to an exemplary embodiment of the present disclosure, and FIG. 2 is an exploded perspective view of a reflector, a motor, and an encoder of a lidar apparatus according to an exemplary embodiment of the present disclosure.

As shown in FIG. 1, the lidar apparatus according to an embodiment of the present disclosure may include a light source 110, a light sensor 120, a reflector 130, a motor 140, an encoder 150, and a controller 160.

The light source 110 emits pulsed light toward the reflector 130 to detect an object, and the light sensor 120 detects reflected light from the object from which the pulsed light is reflected and returned.

The lidar apparatus according to an embodiment of the present disclosure detects the object by calculating the distance from the lidar apparatus to the object by measuring the time difference between the pulsed light and the reflected light.

The light source 110 may be a short-channel light source emitting pulsed light of a short channel or a multichannel light source emitting a plurality of pulsed lights of different channels.

The reflector 130 has a plurality of reflective surfaces, reflects the pulsed light emitted from the light source 110 and transmits it to the object, and reflects the reflected light reflected back from the object and transmits it to the light sensor 120. Here, the reflector 130 may be formed of a polyhedron having a plurality of reflective surfaces disposed on its side surfaces. For example, as shown in FIG. 2, the reflector may be formed of a hexahedron and may have a reflective surface on its four side surfaces, respectively.

The reflector 130 may rotate 360 degrees by the rotational force of the motor 140.

The light source 110 is disposed to face the reflective surface provided in the reflector 130 and emits pulsed light to the reflective surface. Here, the light source 110 may be disposed on a printed circuit board.

Although not shown in the drawings, the lidar apparatus according to an embodiment of the present disclosure may further include a collimation lens positioned between the light source 110 and the reflector 130 in order to improve the directivity of the pulsed light emitted from the light source 110.

Here, the collimation lens prevents the pulsed light emitted from the light source 110 from scattering or dispersing while reaching the reflective surface of the reflector 130.

The light source 110 is disposed to be spaced apart from the reflector 130 by a predetermined interval so as not to be affected by vibrations generated due to the rotation of the reflector 130.

The light sensor 120 is disposed to face the reflective surface of the reflector 130 to receive the reflected light reflected by the reflective surface.

The motor 140 rotates the reflector 130 by 360 degrees, and the encoder 150 detects the rotation position of the reflector 130, that is, the rotation angle, and outputs a detection signal.

Here, the encoder 150 may be formed in the form of a disk having a center of rotation. In addition, as shown in FIG. 1, the encoder 150 may be a magnetic encoder including a multipole magnet 151 and a hall sensor 152, or an optical encoder including a photodiode and a slit member in which a plurality of slits are radially arranged, but is not limited thereto, and an encoder capable of detecting the rotational position of the reflector 130 is sufficient.

The magnetic encoder detects the rotation angle of the reflector 130 by detecting the direction of the multipole magnet 151 in which the Hall sensor 152 rotates. Here, the multipole magnet 151 may have four or more poles and may be arranged radially. And, the optical encoder detects the rotation angle of the reflector 130 by detecting the light passing through the slit by the photodiode.

The reflector 130 and the encoder 150 are coupled to a motor shaft of the motor 140 and rotate together with the motor shaft 141.

Referring to FIG. 2, the encoder 150 is coupled to a base plate 143, and the motor 140 is coupled to the encoder 150. And, the reflector 130 has an accommodation space that can accommodate the motor 140 and the encoder 150, and a lower portion is opened so that the motor 140 and the encoder 150 can be inserted into the accommodation space.

Here, when the motor 140 and the encoder 150 are accommodated in the accommodation space of the reflector 130, the reflector 140 and the motor 150 are coupled through a flange 142 of the upper portion of the motor.

The controller 160 receives a detection signal from the encoder 150, and controls the emission timing of the light source 110 and the detection time of the light sensor 120 using the received detection signal.

Specifically, the controller 160 controls the light source 110 to emit pulsed light when the detection signal is input from the encoder 150. In addition, the controller 160 controls the light source 110 to emit pulsed light at each predetermined rotational position of the reflector 130.

The controller 160 controls the light sensor 120 to detect the reflected light during at least a partial section of the output section of the detection signal.

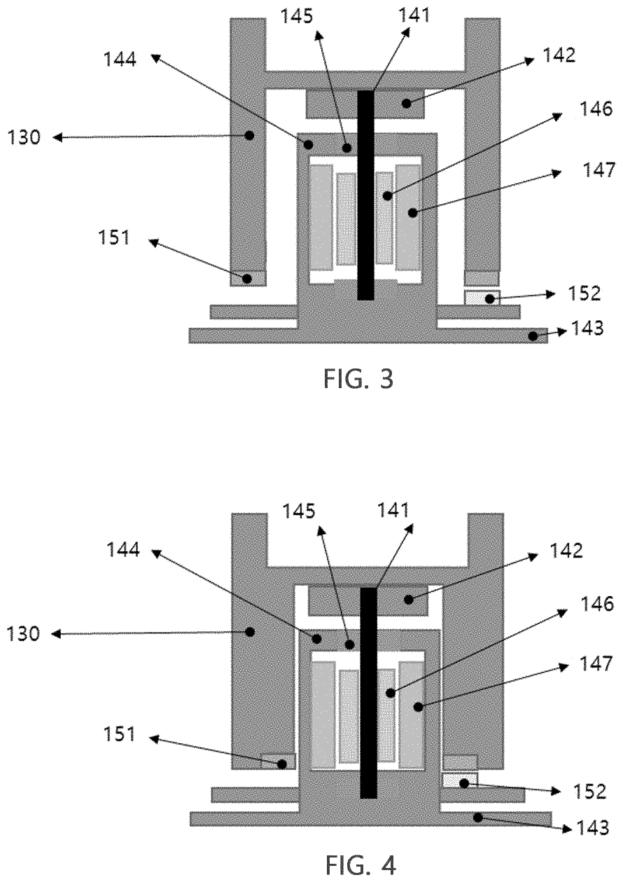

FIG. 3 is a cross-sectional view of a motor of a lidar apparatus according to a first embodiment of the present disclosure, and FIG. 4 is a cross-sectional view of a motor of a lidar apparatus according to a second embodiment of the present disclosure.

The motor of the lidar apparatus according to the first and second embodiments of the present disclosure may be implemented as an inner rotor motor.

Referring to FIGS. 3 and 4, the reflector 130 may be manufactured through mirror-like finishing (e.g., Diamond Turning Machine (DTM)) of an instrument or glass rather than a bonding method.

A motor housing 144 includes a magnet 146, a coil 147, and a motor shaft 141 therein, and the motor shaft 141 passes through the upper part of the motor housing 144 and is exposed to the outside.

Here, the magnet 146 may be coupled to the motor shaft 141, and the coil 147 may be coupled to the inner surface of the motor housing 144. And, a bearing 145 may be provided between the upper portion of the motor housing 144 and the motor shaft 141 so that the motor shaft 141 can rotate.

The motor shaft 141 is coupled to the reflector 144 through the flange 142, and when the motor shaft 141 rotates, the reflector 144 may also rotate together. At this time, when current is supplied to the coil 147, the motor shaft 141 coupled with the magnet 146 may be rotated.

The base plate 143 may be coupled to the bottom surface of the motor housing 144.

The multipole magnet 151 may be coupled to the lower part of the reflector 130 as shown in FIG. 3, or may be inserted into the lower inner side of the reflector 130 as shown in FIG. 4.

In particular, as shown in FIG. 4, the height of the lidar apparatus can be reduced by forming an insertion groove inside the lower inner side of the reflector 130 and inserting the multipole magnet 151 into the insertion groove. In this case, in order to form the insertion groove, the thickness of the reflector 130 may be thicker than that of the reflector 130 of FIG. 3.

The Hall sensor 152 may be disposed under the multipole magnet 151 to detect a rotation angle of the reflector 130.

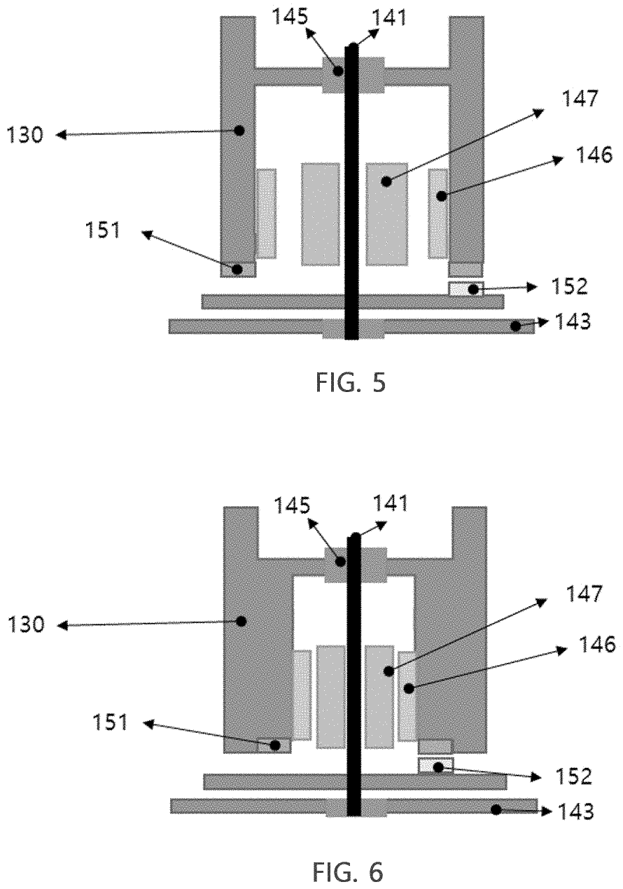

FIG. 5 is a cross-sectional view of a motor of a lidar apparatus according to a third embodiment of the present disclosure, and FIG. 6 is a cross-sectional view of a motor of a lidar apparatus according to a fourth embodiment of the present disclosure.

The motor of the lidar apparatus according to the third and fourth embodiments of the present disclosure may be implemented as an outer rotor motor.

Referring to FIGS. 5 and 6, the reflector 130 may be manufactured through mirror-like finishing (e.g., Diamond Turning Machine (DTM)) of an instrument or glass rather than a bonding method.

The reflector 130 may serve as a motor housing. That is, the reflector 130 includes a magnet 146, a coil 147, and a motor shaft 141 therein, and the motor shaft 141 passes through the upper part of the reflector 130 and is exposed to the outside.

The coil 147 may be coupled to the motor shaft 141, and magnet 146 may be coupled to the inner surface of the reflector 130. And, a bearing 145 may be provided between the upper part of the reflector 130 and the motor shaft 141 so that the reflector 130 can rotate.

At this time, when current is supplied to the coil 47, the reflector 130 coupled with the magnet 146 may be rotated.

The base plate 143 may be coupled to the bottom surface of the reflector 130.

The multipole magnet 151 may be coupled to the lower part of the reflector 130 as shown in FIG. 5, or may be inserted into the lower inner side of the reflector 130 as shown in FIG. 6.

In particular, as shown in FIG. 6, the height of the lidar apparatus can be reduced by forming an insertion groove inside the lower inner side of the reflector 130 and inserting the multipole magnet 151 into the insertion groove. In this case, in order to form the insertion groove, the thickness of the reflector 130 may be thicker than that of the reflector 130 of FIG. 3.

The Hall sensor 152 may be disposed under the multipole magnet 151 to detect a rotation angle of the reflector 130.

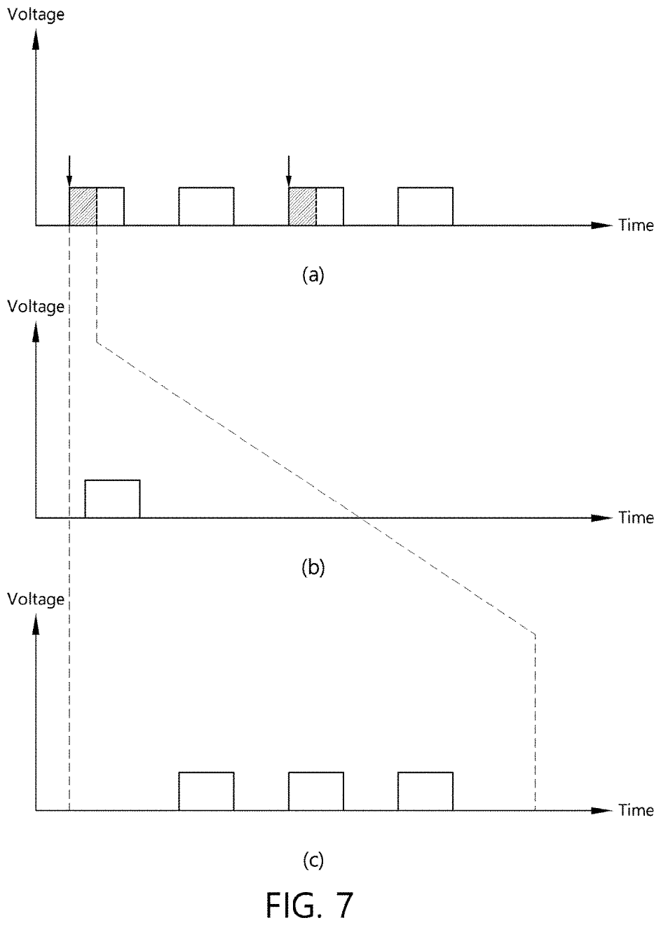

FIG. 7 is a graph showing a detection signal (a) output by an encoder according to a specific rotational position of a reflector, an emission signal (b) of a light source output by a controller according to the detection signal, and a sensing signal (c) in which a light sensor detects reflected light during a specific section of the output section of the detection signal, respectively, in a lidar apparatus according to an exemplary embodiment of the present disclosure.

In FIG. 7, the horizontal axis represents time, and the vertical axis represents the magnitude of a signal (voltage).

First, referring to (a) of FIG. 7, the encoder 150 detects a specific rotational position of the reflector 130 at regular or irregular intervals when the reflector 130 rotates. In this case, when the reflector 130 is rotated using a relatively low-spec motor 150, the reflector 130 does not rotate at a constant speed, so the intervals between specific rotational positions may be irregular.

And, the encoder 150 outputs a high-level detection signal whenever a specific rotational position of the reflector 130 is detected. In this case, each of the high-level detection signals may be continued for a predetermined time.

Next, referring to (a) and (b) of FIG. 7, the controller 160 receives a detection signal input from the encoder 150 and controls the light source 110 to emit pulsed light every time a high-level detection signal is input or every predetermined input interval of a high-level detection signal. For example, as shown in the drawing, the controller 160 may control the light source to emit pulsed light whenever an odd-numbered high-level detection signal is input (indicated by an arrow).

In addition, when a high-level detection signal is input from the encoder 150, the controller 160 outputs a high-level emission signal to the light source 110. Then, the light source 110 emits pulsed light according to the emission signal input from the controller 160. In the above-described example, the controller 160 may output a high-level emission signal to the light source 110 when an odd-numbered high-level detection signal is input. In this case, the rising time of the detection signal and the rising time of the emission signal may be different due to the delay on the signal path. That is, the rising time of the emission signal may be delayed than that of the detection signal. Although this signal delay value corresponds to a very short time in units of several microseconds (u s), it is possible to solve the signal delay problem by reflecting this in advance in the output timing of the emission signal.

As such, in the lidar apparatus according to an embodiment of the present disclosure, even if the motor 140 does not rotate at a constant speed, the encoder 150 detects a specific rotational position of the reflector 130, and the controller 160 controls the light source 110 to emit pulsed light at the detected specific rotational position, and thus the horizontal resolution of the lidar apparatus can be improved and also it is possible to use a relatively low-spec motor for the lidar apparatus, thereby reducing the manufacturing cost of the lidar apparatus.

Next, referring to (a) and (c) of FIG. 7, the controller 160 controls the light sensor 120 to detect the reflected light reflected back from the object during a specific detection time, that is, at least a partial section of the output section of the high-level detection signal output by the encoder 150. In this case, the output section of the high-level detection signal is a section in which the light sensor 120 has a relatively high probability of receiving the reflected light reflected by the object, and the first half of the output section is more likely to be detected than the second half.

And, the light sensor 120 receives the reflected light simultaneously or sequentially for a specific detection time and outputs a high-level sensing signal. Here, the light sensor 120 detects the reflected light only during a specific detection time, and does not operate during other times. For example, as shown in the drawing, the light sensor 120 may be controlled to detect the reflected light during the section from the rising time to the 1/2 point (hatched area) of the output section of the high-level detection signals output by the encoder 150. In this case, the light sensor 120 may detect at least one or more reflected lights having different detection times according to a distance from the object.

As such, in the lidar apparatus according to an embodiment of the present disclosure, the light sensor 120 detects the reflected light only during a specific detection time with a high probability of receiving the reflected light, and thus it is possible to block detection of a noise signal unnecessary for object detection and to reduce a data capacity for processing the sensing signal.

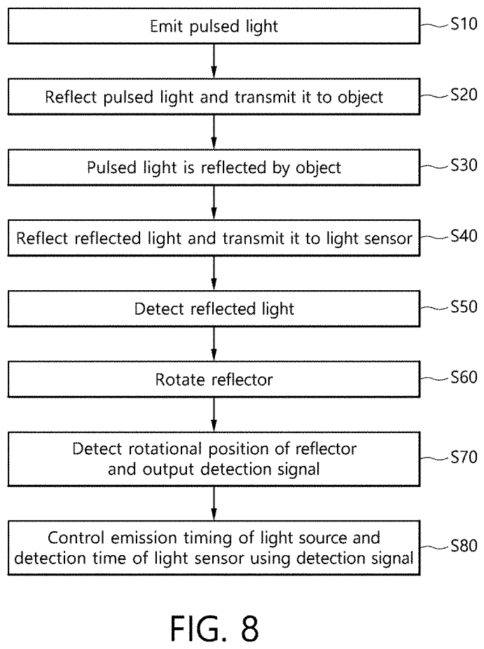

FIG. 8 is a flowchart of a control method of a lidar apparatus according to an exemplary embodiment of the present disclosure.

Hereinafter, a control method of a lidar apparatus according to an exemplary embodiment of the present disclosure will be described with reference to FIGS. 1 to 8.

First, the light source 110 emits pulsed light toward the reflector 130 to detect the object at step S10. In this case, the light source 110 is disposed to face the reflective surface provided in the reflector 130 and emits pulsed light to the reflective surface.

Next, the reflector 130 reflects the pulsed light and transmits it to the object at step S20. Then, the pulsed light is reflected by the object at step S30.

Next, the reflector 130 reflects the reflected light reflected by the object and transmits it to the light sensor 120 at step S40. Then, the light sensor 120 detects the reflected light at step S50.

The lidar apparatus according to an embodiment of the present disclosure detects the object by calculating the distance from the lidar apparatus to the object by measuring the time difference between the pulsed light and the reflected light.

Next, the motor 140 rotates the reflector 130 by 360 degrees at step S60. Then, the encoder 150 detects the rotational position of the reflector 130 and outputs a detection signal at step S70.

Then, the controller 160 receives the detection signal input from the encoder 150, and controls the emission timing of the light source 110 and the detection time of the light sensor 120 using the detection signal at step S80.

In this case, the controller 160 controls the light source 110 to emit pulsed light when the detection signal is input from the encoder 150. In addition, the controller 160 controls the light source 110 to emit pulsed light at each predetermined rotational position of the reflector 130.

The controller 160 controls the light sensor 120 to detect the reflected light during at least a partial section of the output section of the detection signal.

As such, in the control method of the lidar apparatus according to an embodiment of the present disclosure, even if the motor 140 does not rotate at a constant speed, the encoder 150 detects a specific rotational position of the reflector 130, and the controller 160 controls the light source 110 to emit pulsed light at the detected specific rotational position, and thus the horizontal resolution of the lidar apparatus can be improved and also it is possible to use a relatively low-spec motor for the lidar apparatus, thereby reducing the manufacturing cost of the lidar apparatus.

In addition, in the control method of the lidar apparatus according to an embodiment of the present disclosure, the light sensor 120 detects the reflected light only during a specific detection time with a high probability of receiving the reflected light, and thus it is possible to block detection of a noise signal unnecessary for object detection and to reduce a data capacity for processing the sensing signal.

Although exemplary embodiments of the present disclosure have been described above, the spirit of the present disclosure is not limited to the embodiments set forth herein. Those of ordinary skill in the art who understand the spirit of the present disclosure may easily propose other embodiments through supplement, change, removal, addition, etc. of elements within the scope of the same spirit, but the embodiments will be also within the scope of the present disclosure.

What is claimed is:

1. A lidar apparatus, comprising:
a light source for emitting pulsed light;
a light sensor for detecting reflected light by an object from which the pulsed light is reflected and returned;
a reflector having a plurality of reflective surfaces, and for reflecting the pulsed light and transmitting it to the object, and reflecting the reflected light and transmitting it to the light sensor;
a motor provided inside the reflector and comprising: a motor housing, a motor shaft accommodated in the motor housing and coupled to the reflector, a magnet coupled to the motor shaft, and a coil coupled to an inner surface of the motor housing;
an encoder for detecting a rotational position of the reflector and outputting a detection signal; and
a controller for controlling emission timing of the light source and detection time of the light sensor using the detection signal.

2. The lidar apparatus of claim 1, wherein the controller controls the light source to emit the pulsed light when the detection signal is input from the encoder.

3. The lidar apparatus of claim 2, wherein the controller controls the light source to emit the pulsed light at each predetermined rotational position of the reflector.

4. The lidar apparatus of claim 1, wherein the controller controls the light sensor to detect the reflected light during at least a partial section of an output section of the detection signal.

5. The lidar apparatus of claim 1, wherein the reflector is formed of a polyhedron having the plurality of reflective surfaces disposed on its side surfaces.

6. The lidar apparatus of claim 1, wherein the encoder comprises:
a multipole magnet coupled to a lower part of the reflector and rotating together with the reflector; and
a hall sensor configured to detect a rotation angle of the reflector by detecting a direction of the multipole magnet.

7. The lidar apparatus of claim 6, wherein the multipole magnet is inserted into an inner surface of a lower part of the reflector.

8. The lidar apparatus of claim 1, wherein the reflector is rotated by rotation of the motor shaft.

9. The lidar apparatus of claim 1, further comprising a flange for coupling the motor shaft to an inner upper surface of the reflector.

10. A lidar apparatus, comprising:
a light source for emitting pulsed light;
a light sensor for detecting reflected light by an object from which the pulsed light is reflected and returned;
a reflector having a plurality of reflective surfaces, and for reflecting the pulsed light and transmitting it to the object, and reflecting the reflected light and transmitting it to the light sensor;
a motor provided inside the reflector and comprising: a motor shaft coupled to the reflector, a coil coupled to the motor shaft, and a magnet coupled to an inner surface of the reflector;
an encoder for detecting a rotational position of the reflector and outputting a detection signal; and
a controller for controlling emission timing of the light source and detection time of the light sensor using the detection signal.

11. The lidar apparatus of claim 10, wherein the controller controls the light source to emit the pulsed light when the detection signal is input from the encoder.

12. The lidar apparatus of claim 11, wherein the controller controls the light source to emit the pulsed light at each predetermined rotational position of the reflector.

13. The lidar apparatus of claim 10, wherein the controller controls the light sensor to detect the reflected light during at least a partial section of an output section of the detection signal.

14. The lidar apparatus of claim 10, wherein the reflector is formed of a polyhedron having the plurality of reflective surfaces disposed on its side surfaces.

15. The lidar apparatus of claim 10, wherein the encoder comprises:
a multipole magnet coupled to a lower part of the reflector and rotating together with the reflector; and
a hall sensor configured to detect a rotation angle of the reflector by detecting a direction of the multipole magnet.

16. The lidar apparatus of claim 15, wherein the multipole magnet is inserted into an inner surface of a lower part of the reflector.

17. The lidar apparatus of claim 10, wherein the reflector is rotated by rotation of the magnet.

18. The lidar apparatus of claim 10, wherein the motor shaft is inserted through an inner upper surface of the reflector.

19. The lidar apparatus of claim 18, further comprising a bearing disposed between the motor shaft and the reflector.
